(19) United States
(12) Patent Application Publication
(10) Pub. No.: US 2013/0015792 A1
(43) Pub. Date: Jan. 17, 2013

(54) MOTOR DRIVING CIRCUIT AND MOTOR DEVICE

(71) Applicant: Toshikazu Sekihara, Kawasaki-shi (JP)

(72) Inventor: Toshikazu Sekihara, Kawasaki-shi (JP)

(73) Assignee: KABUSHIKI KAISHA TOSHIBA, Tokyo (JP)

(21) Appl. No.: 13/371,595

(22) Filed: Feb. 13, 2012

(30) Foreign Application Priority Data
Jul. 11, 2011 (JP) 2011-152796

(51) Int. Cl. H02P 6/14

(52) U.S. Cl. 318/400.1

(57) ABSTRACT

A motor driving circuit has a driving controlling signal generating circuit that controls a driver with a driving controlling signal, the driver supplying a driving voltage that drives the motor to the motor. The motor driving circuit has a mode selecting circuit that detects a power supply voltage supplied from a power supply to the driver, outputs a normal operation mode signal indicative of a normal operation to the driving controlling signal generating circuit if the power supply voltage is equal to or higher than a preset first threshold, and outputs a test operation mode signal indicative of a test operation to the driving controlling signal generating circuit if the power supply voltage is lower than the first threshold.

### CROSS-REFERENCE TO RELATED APPLICATION

This application is based upon and claims the benefit of priority from the prior Japanese Patent Application No. 2011-152796, filed on Jul. 11, 2011, the entire contents of which are incorporated herein by reference.

### BACKGROUND

1. Field

Embodiments described herein relate generally to a motor driving circuit and a motor device.

2. Background Art

Recent electronic devices use motors for various purposes. Depending on the purposes, motor driving circuits that drive motors operate on different driving principles, under different operating conditions, and with different characteristics.

Such motor driving circuits need to be tested to check if the circuits normally operate or not.

### BRIEF DESCRIPTION OF THE DRAWINGS

FIG. 1 is a diagram showing an example of a configuration of a motor driving system 1000 according to a first embodiment; and

FIG. 2 is a diagram showing an example of a configuration of a motor driving system 2000 according to the second embodiment.

### DETAILED DESCRIPTION

A motor driving circuit that controls driving of a motor based on communication with an external microcomputer, motor driving circuit according to an embodiment. The motor driving circuit has a driving controlling signal generating circuit that controls a driver with a driving controlling signal, the driver supplying a driving voltage that drives the motor to the motor. The motor driving circuit has a mode selecting circuit that detects a power supply voltage supplied from a power supply to the driver, outputs a normal operation mode signal indicative of a normal operation to the driving controlling signal generating circuit if the power supply voltage is equal to or higher than a preset first threshold, and outputs a test operation mode signal indicative of a test operation to the driving controlling signal generating circuit if the power supply voltage is lower than the first threshold.

The driving controlling signal generating circuit controls the driver with the driving controlling signal to cause the normal operation of the motor in response to the normal operation mode signal.

The driving controlling signal generating circuit controls the driver with the driving controlling signal to cause the test operation of the motor in response to the test operation mode signal.

### Comparative Example

When users perform initial investigation using a motor driving circuit, for example, it is advantageous that the motor driving circuit has a test operation mode in which the motor driving circuit outputs an drive waveform regardless of the specifications or load conditions of the motor.

Besides, during manufacture of the motor driving circuit, an drive test, an operational check test with no load on the motor or the like is carried out. In the operational check test, a desired operation cannot be achieved in some cases because the load conditions differ from the actual ones. Thus, it is advantageous that the motor driving circuit has the test operation mode.

In particular, the test operation mode is effective for driving a three-phase brushless DC motor that requires complicated control.

There is another technique that allows a motor driving circuit to perform a test operation (a basic control without an additional control such as forced commutation and automatic advance angle control, for example) based on a test signal from a microcomputer.

In general, in the case where a motor device (a product) incorporates the motor driving circuit that is a semiconductor device, which has only a small number of input and output lines including two lines connected to a direct-current power supply and several lines connected to the microcomputer, the test operation of the motor driving circuit is restricted by restrictions on signal transmission between the microcomputer and the motor driving circuit, that is, the motor device.

Thus, according to embodiments, there is provided a motor driving circuit that can more properly perform the test operation while avoiding restrictions on signal transmission.

In the following, the embodiments will be described with reference to the drawings. In the following embodiments, cases where the present invention is applied to a control of a three-phase motor, whose number of revolutions is controlled by a three-phase driving voltage, will be described. However, the present invention can be equally applied to other types of motors whose number of revolutions is controlled by a driving voltage.

### First Embodiment

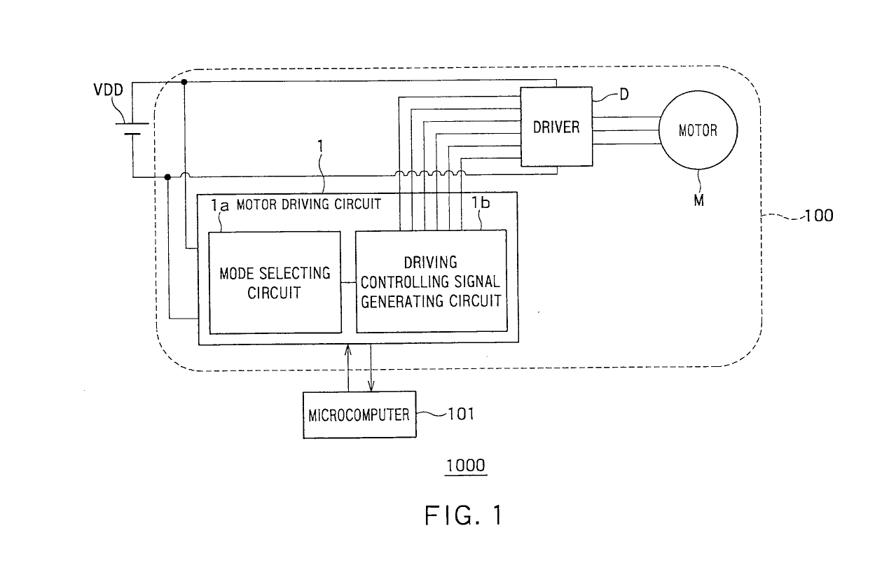

FIG. 1 is a diagram showing an example of a configuration of a motor driving system 1000 according to a first embodiment.

As shown in FIG. 1, the motor driving system 1000 includes a motor driving circuit 1, a driver D, a microcomputer 101, a motor M and a direct-current power supply VDD.

The motor driving system 1000 is used for driving a fan or a compressor in a product such as an air conditioner and a refrigerator, for example.

The microcomputer 101 is configured to output a number-of-revolutions controlling signal, which defines the number of revolutions of the motor M, to the motor driving circuit 1. The microcomputer 101 is also configured to perform a predetermined control on the product such as an air conditioner and a refrigerator described above.

The direct-current power supply VDD is configured to output a power supply voltage.

In this embodiment, the motor M is a three-phase motor (more specifically, a three-phase brushless DC motor). However, the motor M may be other types of motor whose number of revolutions is controlled by a driving voltage as described above.

The driver D is connected to the direct-current power supply VDD and is supplied with the power supply voltage from the direct-current power supply VDD. The driver D generates a three-phase driving voltage for driving the motor M from the power supply voltage. The driver D is configured to supply the three-phase driving voltage for driving the motor M to the motor M in response to a driving controlling signal.

The driver D controls six or three pairs of series connection of MOS transistors (not shown) between the power supply voltage and a ground voltage according to the driving controlling signal, thereby outputting the three-phase driving voltage from the points of connection of the MOS transistors.

The three-phase driving voltage produces currents through the coils of the three phases, thereby driving the motor M.

The motor driving circuit 1 is configured to control the driver D (the three-phase driving voltage applied to the motor M) with the driving controlling signal based on communication with the external microcomputer 101, thereby controlling driving of the motor M.

The motor driving circuit 1 includes a motor selecting circuit 1a and a driving controlling signal generating circuit 1b.

The mode selecting circuit 1a detects the power supply voltage supplied from the power supply VDD to the driver D. The detection of the power supply voltage by the mode selecting circuit 1a can be accomplished by an existing technique such as by detecting the power supply voltage by resistive division.

If the power supply voltage is equal to or higher than a preset first threshold V1 (150V, for example), the mode selecting circuit 1a outputs a normal operation mode signal indicative of a normal operation to the driving controlling signal generating circuit 1b.

If the power supply voltage is lower than the first threshold V1, the mode selecting circuit 1a outputs a test operation mode signal indicative of a test operation to the driving controlling signal generating circuit 1b.

Alternatively, the mode selecting circuit is may be configured to output the test operation mode signal when the power supply voltage is continuously lower than the first threshold V1 for a preset reference period.

More preferably, the mode selecting circuit 1a may be configured to output the test operation mode signal to the driving controlling signal generating circuit 1b when the power supply voltage is lower than a second threshold (100V, for example) lower than the first threshold V1.

In this way, the normal operation and the test operation can be clearly discriminated.

In particular, the mode selecting circuit 1a can be configured to output the test operation mode signal when the power supply voltage is continuously lower than the second threshold V2 for a preset reference period.

More preferably, the mode selecting circuit is may be configured to output the test operation mode signal to the driving controlling signal generating circuit 1b when the power supply voltage is lower than the second threshold V2 and equal to or higher than a third threshold V3 (50V, for example) lower than the second threshold.

In particular, the mode selecting circuit is can be configured to output the test operation mode signal when the power supply voltage is continuously lower than the second threshold V2 and equal to or higher than the third threshold V3 for a preset reference period.

In this case, the test operation occurs when the power supply voltage is equal to or higher than the minimum voltage required for normal test operation, so that the test operation can be accomplished with higher reliability.

The driving controlling signal generating circuit 1b is configured to control the driver D with the driving controlling signal. As a result, the driver D supplies the three-phase driving voltage for driving the motor M to the motor M according to the driving controlling signal.

For example, in the normal operation, based on the number-of-revolutions controlling signal (instruction) that specifies the number of revolutions of the motor M input from the microcomputer 101, the driving controlling signal generating circuit 1b generates a driving controlling signal to drive the motor M at the number of revolutions specified by the number-of-revolutions controlling signal. That is, in response to the normal operation mode signal, the driving controlling signal generating circuit 1b controls the driver D with the driving controlling signal to achieve normal operation of the motor M.

In the test operation, the driving controlling signal generating circuit 1b generates a driving controlling signal to drive the motor M at the number of revolutions specified for the test operation. That is, in response to the test operation mode signal, the driving controlling signal generating circuit 1b controls the driver D with the driving controlling signal to achieve test operation of the motor M.

The driving controlling signal generating circuit 1b may be configured not to output a driving controlling signal when the power supply voltage is a voltage (125V, for example) between the first threshold V1 and the second threshold V2, for example.

As described above, the normal operation is an operation to rotate the motor M at the number of revolutions specified by the instruction (number-of-revolutions controlling signal) from the microcomputer 101, for example. In this case, the test operation is an operation to rotate the motor M at a certain frequency by forced commutation, for example.

The normal operation may include detecting the driving current of the motor M, estimating the advance angle of the motor M from the detection result, and rotating the motor M while adjusting the advance angle of the motor M so that the estimated advance angle is a predetermined value, for example. In this case, the test operation is an operation to rotate the motor M without adjusting the advance angle of the motor M, for example.

The driving controlling signal generating circuit 1b outputs the driving controlling signal when the driving controlling signal generating circuit 1b receives a number-of-revolutions controlling signal that instructs to rotate the motor M from the microcomputer 101, and does not output the driving controlling signal when the driving controlling signal generating circuit 1b receives a number-of-revolutions controlling signal that instructs to stop the motor from the microcomputer 101, for example.

Generation of the driving controlling signals by the driving controlling signal generating circuit 1b in the normal operation and the test operation can be accomplished by existing techniques.

As described above, in the case where the motor driving circuit 1 is incorporated in the motor device 100, the motor driving circuit 1 has only a small number of input and output lines: two lines connected to the direct-current power supply and several lines connected to the microcomputer.

Nevertheless, the motor device 100 according to this embodiment can be tested in the same manner as conventional, since the test operation occurs according to the voltage of the power supply VDD.

Next, an example of the operation of the motor device 100 configured as described above will be described.

A case where switching between the normal operation and the test operation occurs at the first threshold will be described.

First, the power supply voltage output from the power supply VDD rises from zero.

Then, if the power supply voltage is continuously lower than the first threshold V1 for the preset reference period, the mode selecting circuit is outputs the test operation mode signal to the driving control signal generating circuit 1b.

In response to the test operation mode signal, the driving controlling signal generating circuit 1b controls the driver D with the driving controlling signal to achieve the test operation of the motor M if the number-of-revolutions controlling signal that instructs to rotate the motor M is input to the driving control signal generating circuit 1b from the microcomputer 101, for example.

If the power supply voltage is equal to or higher than the first threshold V1, the mode selecting circuit 1a outputs the normal operation mode signal to the driving controlling signal generating circuit 1b.

In response to the normal operation mode signal, the driving controlling signal generating circuit 1b generates the driving controlling signal to drive the motor M at the number of revolutions specified by the number-of-revolutions controlling signal, according to the number-of-revolutions controlling signal (instruction) that specifies the number of revolutions of the motor M input from the microcomputer 101. The driving controlling signal generating circuit 1b controls the driver D with the driving controlling signal to achieve the normal operation of the motor M.

Alternatively, the mode selecting circuit 1a may be configured to switch to the test operation when the power supply voltage is continuously equal to or lower than the second threshold V2.

In this case, first, the power supply voltage output from the power supply VDD rises from zero.

Then, if the power supply voltage is between zero and the third threshold V3 (25V, for example), the mode selecting circuit 1a does not output the normal operation mode signal and the test operation mode signal.

As a result, the driving controlling signal generating circuit 1b outputs no driving controlling signal. In other words, the motor M is in the stopped state.

If the power supply voltage is continuously lower than the second threshold V2 (100V, for example) and equal to or higher than the third threshold V3 for the reference period, the mode selecting circuit 1a outputs the test operation mode signal to the driving controlling signal generating circuit 1b.

In response to the test operation mode signal, the driving controlling signal generating circuit 1b controls the driver D with the driving controlling signal to achieve the test operation of the motor M if the number-of-revolutions controlling signal that instructs to rotate the motor M is input to the driving control signal generating circuit 1b from the microcomputer 101, for example.

As described above, the test operation occurs when the power supply voltage is equal to or higher than the minimum voltage required for normal test operation, so that the test operation can be accomplished with higher reliability.

If the power supply voltage is a voltage (125V, for example) between the first threshold V1 and the second threshold V2, the mode selecting circuit 1a does not output the normal operation mode signal and the test operation mode signal.

As a result, the driving controlling signal generating circuit 1b outputs no driving controlling signal. In other words, the motor M is in the stopped state.

As described above, since the stopped state is provided, the normal operation and the test operation can be clearly discriminated.

If the power supply voltage is equal to or higher than the first threshold V1, the mode selecting circuit is output the normal operation mode signal to the driving controlling signal generating circuit 1b.

In response to the normal operation mode signal, the driving controlling signal generating circuit 1b generates the driving controlling signal to drive the motor M at the number of revolutions specified by the number-of-revolutions controlling signal, according to the number-of-revolutions controlling signal (instruction) that specifies the number of revolutions of the motor M input from the microcomputer 101. The driving controlling signal generating circuit 1b controls the driver D with the driving controlling signal to achieve the normal operation of the motor M.

That is, despite restrictions on the signal transmission between the microcomputer and the motor driving circuit, that is, the motor device, switching between the test operation and the normal operation can be accomplished by changing the voltage of the power supply.

As described above, according to the first embodiment, a test can be performed according to the voltage of the power supply. Therefore, there are no restrictions on the signals between the microcomputer and the motor driving circuit, and the accuracy of the signals can be improved.

In addition, when users perform initial investigation using the motor driving circuit, for example, the motor driving circuit outputs an drive waveform regardless of the specifications or load conditions of the motor, so that improvement of the efficiency of development can be expected.

In addition, during manufacture of the controlling circuit provided with the motor driving circuit, even if a desired operation cannot be achieved in an drive test or an operational check test with no load on the motor because the load conditions differ from the actual ones, a test can be performed in the test operation mode.

In addition, if the test operation includes an evaluation test during manufacture of the motor driving circuit, there is another advantage that the evaluation test can be performed.

As described above, the motor device 100 according to the first embodiment can properly perform the test operation while avoiding restrictions on signal transmission.

### Second Embodiment

According to the first embodiment described above, the motor driving circuit does not include the driver.

According to a second embodiment described below, the motor driving circuit includes the driver.

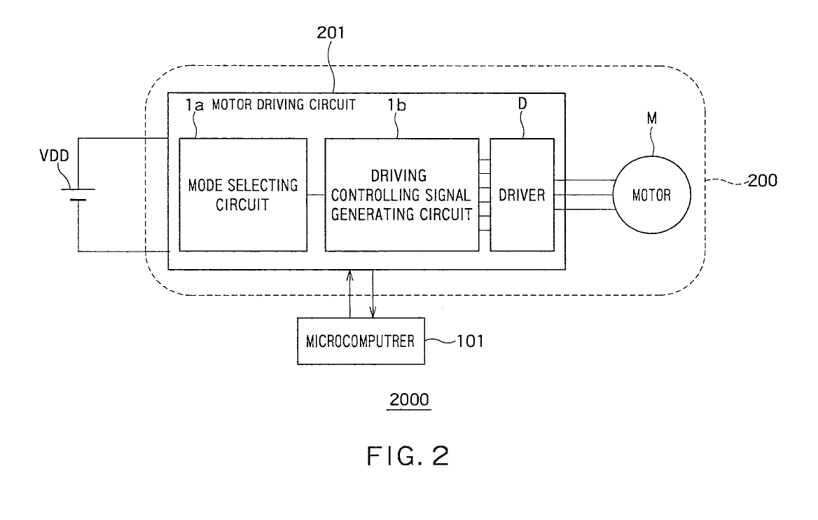

FIG. 2 is a diagram showing an example of a configuration of a motor driving system 2000 according to the second embodiment. In FIG. 2, the same reference numerals as those in FIG. 1 denote the same components as those according to the first embodiment unless otherwise specified.

As shown in FIG. 2, the motor driving system 2000 includes a motor driving circuit 201, the microcomputer 101 and the motor M.

The motor driving circuit 201 includes the mode selecting circuit 1a, the driving controlling signal generating circuit 1b and the driver circuit D.

As described above, the motor driving circuit 201 differs from the motor driving circuit 1 according to the first embodiment in that the motor driving circuit 201 includes the driver D.

In the other respects, however, a motor device 200 is the same as the motor device 100 according to the first embodiment.

That is, the motor device 200 according to the second embodiment can perform a test in the same way as conventional, since the test operation is accomplished according to the voltage of the power supply VDD as in the first embodiment.

The motor device 200 configured as described above operates in the same way as the motor device 100 according to the first embodiment.

That is, according to the second embodiment, a test can be performed according to the voltage of the power supply, as in the first embodiment. As a result, there are no restrictions on the signals between the microcomputer and the motor driving circuit, and the accuracy of the signals can be improved.

In addition, as in the first embodiment, when users perform initial investigation using the motor driving circuit, for example, the motor driving circuit outputs an drive waveform regardless of the specifications or load conditions of the motor, so that improvement of the efficiency of development can be expected.

In addition, as in the first embodiment, during manufacture of the controlling circuit provided with the motor driving circuit, even if a desired operation cannot be achieved in an drive test or an operational check test with no load on the motor because the load conditions differ from the actual ones, a test can be performed in the test operation mode.

In addition, as in the first embodiment, if the test operation includes an evaluation test during manufacture of the motor driving circuit, there is another advantage that the evaluation test can be performed.

As described above, the motor device 200 according to the second embodiment can properly perform the test operation while avoiding restrictions on signal transmission, as with the motor device 100 according to the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A motor driving circuit that controls driving of a motor based on communication with an external microcomputer, comprising:
a driving controlling signal generating circuit that controls a driver with a driving controlling signal, the driver supplying a driving voltage that drives the motor to the motor; and
a mode selecting circuit that detects a power supply voltage supplied from a power supply to the driver, outputs a normal operation mode signal indicative of a normal operation to the driving controlling signal generating circuit if the power supply voltage is equal to or higher than a preset first threshold, and outputs a test operation mode signal indicative of a test operation to the driving controlling signal generating circuit if the power supply voltage is lower than the first threshold,
wherein the driving controlling signal generating circuit
controls the driver with the driving controlling signal to cause the normal operation of the motor in response to the normal operation mode signal, and
controls the driver with the driving controlling signal to cause the test operation of the motor in response to the test operation mode signal.

2. The motor driving circuit according to claim 1, wherein the mode selecting circuit outputs the test operation mode signal to the driving controlling signal generating circuit if the power supply voltage is lower than a second threshold that is lower than the first threshold.

3. The motor driving circuit according to claim 2, wherein the driving controlling signal generating circuit does not output the driving controlling signal if the power supply voltage is a voltage between the first threshold and the second threshold.

4. The motor driving circuit according to claim 2, wherein the mode selecting circuit outputs the test operation mode signal when the power supply voltage is lower than the second threshold and equal to or higher than the third threshold lower than the second threshold.

5. The motor driving circuit according to claim 2, wherein the mode selecting circuit outputs the test operation mode signal when the power supply voltage is continuously lower than the second threshold for a preset reference period.

6. The motor driving circuit according to claim 1, wherein the mode selecting circuit outputs the test operation mode signal when the power supply voltage is continuously lower than the first threshold for a preset reference period.

7. The motor driving circuit according to claim 1, wherein the normal operation is an operation to rotate the motor at a number of revolutions specified by an instruction from the microcomputer by controlling an advance angle of the motor, and
the test operation is an operation to rotate the motor at a certain frequency by forced commutation without controlling the advance angle of the motor.

8. The motor driving circuit according to claim 1, wherein the driving controlling signal generating circuit
controls the driver with the driving controlling signal to cause the test operation of the motor if a number-of-revolutions controlling signal that instructs to rotate the motor is input from the microcomputer to the driving controlling signal generating circuit in the case where the driving controlling signal generating circuit receives the test operation mode signal output from the mode selecting circuit, and
does not output the driving controlling signal if a number-of-revolutions controlling signal that instructs to stop the motor is input from the microcomputer to the driving controlling signal generating circuit in the case where the driving controlling signal generating circuit receives the test operation mode signal output from the mode selecting circuit.

9. The motor driving circuit according to claim 1, further comprising the driver.

10. The motor driving circuit according to claim 1, wherein the motor is a three-phase brushless DC motor.

11. A motor device, comprising:
a motor;
a driver that supplies a driving voltage that drives the motor to the motor; and
a motor driving circuit that controls driving of the motor by controlling the driver with a driving controlling signal based on communication with an external microcomputer,
wherein the motor driving circuit comprising:
a driving controlling signal generating circuit that controls the driver with a driving controlling signal, the driver supplying a driving voltage that drives the motor to the motor; and
a mode selecting circuit that detects a power supply voltage supplied from a power supply to the driver, outputs a normal operation mode signal indicative of a normal operation to the driving controlling signal generating circuit if the power supply voltage is equal to or higher than a preset first threshold, and outputs a test operation mode signal indicative of a test operation to the driving controlling signal generating circuit if the power supply voltage is lower than the first threshold,
wherein the driving controlling signal generating circuit
controls the driver with the driving controlling signal to cause the normal operation of the motor in response to the normal operation mode signal, and
controls the driver with the driving controlling signal to cause the test operation of the motor in response to the test operation mode signal.

12. The motor device according to claim 11, wherein the mode selecting circuit outputs the test operation mode signal to the driving controlling signal generating circuit if the power supply voltage is lower than a second threshold that is lower than the first threshold.

13. The motor device according to claim 12, wherein the driving controlling signal generating circuit does not output the driving controlling signal if the power supply voltage is a voltage between the first threshold and the second threshold.

14. The motor device according to claim 12, wherein the mode selecting circuit outputs the test operation mode signal when the power supply voltage is lower than the second threshold and equal to or higher than the third threshold lower than the second threshold.

15. The motor device according to claim 12, wherein the mode selecting circuit outputs the test operation mode signal when the power supply voltage is continuously lower than the second threshold for a preset reference period.

16. The motor device according to claim 11, wherein the mode selecting circuit outputs the test operation mode signal when the power supply voltage is continuously lower than the first threshold for a preset reference period.

17. The motor device according to claim 11, wherein the normal operation is an operation to rotate the motor at a number of revolutions specified by an instruction from the microcomputer by controlling an advance angle of the motor, and
the test operation is an operation to rotate the motor at a certain frequency by forced commutation without controlling the advance angle of the motor.

18. The motor device according to claim 11, wherein the driving controlling signal generating circuit
controls the driver with the driving controlling signal to cause the test operation of the motor if a number-of-revolutions controlling signal that instructs to rotate the motor is input from the microcomputer to the driving controlling signal generating circuit in the case where the driving controlling signal generating circuit receives the test operation mode signal output from the mode selecting circuit, and
does not output the driving controlling signal if a number-of-revolutions controlling signal that instructs to stop the motor is input from the microcomputer to the driving controlling signal generating circuit in the case where the driving controlling signal generating circuit receives the test operation mode signal output from the mode selecting circuit.

19. The motor device according to claim 12, wherein the driving controlling signal generating circuit
controls the driver with the driving controlling signal to cause the test operation of the motor if a number-of-revolutions controlling signal that instructs to rotate the motor is input from the microcomputer to the driving controlling signal generating circuit in the case where the driving controlling signal generating circuit receives the test operation mode signal output from the mode selecting circuit, and
does not output the driving controlling signal if a number-of-revolutions controlling signal that instructs to stop the motor is input from the microcomputer to the driving controlling signal generating circuit in the case where the driving controlling signal generating circuit receives the test operation mode signal output from the mode selecting circuit.

20. The motor device according to claim 11, wherein the motor is a three-phase brushless DC motor.
